(19) United States
(12) Patent Application Publication
(10) Pub. No.: US 2011/0151391 A1
(43) Pub. Date: Jun. 23, 2011

(54) Orthodontic Brackets and Devices

(76) Inventors: Jeng-Kang Richard Shih, San Diego, CA (US); William How-Hong Shih, San Diego, CA (US); Stephen How-Ping Shih, San Diego, CA (US)

(21) Appl. No.: 12/983,310

(22) Filed: Jan. 2, 2011

Related U.S. Application Data
(63) Continuation-in-part of application No. 12/583,378, filed on Aug. 20, 2009, now abandoned.

(51) Int. Cl. A61C 7/28; A61C 7/12

(52) U.S. Cl. 433/10; 433/8

(57) ABSTRACT

The invention relates to a bracket for fixing to the exterior face of a tooth, the bracket having a base, which lies against the tooth and in which a trapezoid shape slot is configured to receive a wire bow. The base of the slot runs essentially perpendicularly in the oral cavity with elevated surface, thus retaining the wire bow, which exerts forces and torques in an essentially horizontal direction, in an optimum position in the slot. The unique form of the inventive brackets has a dimple concave female surface and a channel for attachments to passes through which would allow the female to receive a convex male surface extension from the attachments and form a locking mechanism between concave female surface and the attachment convex male extension when attachment is used during the Orthodontic treatment. This unique model of locking mechanism has created a new inventive platform in Orthodontics for interchangeable attachments. The invention also characterized with an elevated table in order to optimize the torque and facilitate the displacement of the dental bow into its ideal position and the fixing of the brackets to the tooth.

### BACKGROUND OF THE INVENTION

The present invention relates to an orthodontic device.

### DESCRIPTION OF THE PRIOR ART

U.S. Pat. No. 5,037,297, U.S. Pat. No. 4,941,825, and U.S. Pat. No. 4,838,787. All three patents describe orthodontic brackets of a type known in the prior art.

In conventional orthodontic treatments, two methods of treatment are primarily used. The first technique is known as the edgewise technique, which consists of applying moving force to the tooth by the use of a bracket having a rectangularly sectioned arch wire receiving slot with an arch wire received therein. The tooth is moved by the application of angular torque to the bracket by the square sectioned arch wire. This torque is transferred to the underlying tooth, attached to the bracket, which then moves in the desired direction. A variation on the edgewise technique is the straight wire technique. In the straight wire technique, the torque and angulation are preadjusted in the bracket.

The second technique uses a lighter wire and is known as the Begg light wire technique. This technique is characterized by the application of a light, round-sectioned arch wire, the force being applied to the tooth bracket by a different form of attachment of the light wire to the bracket. The result is similar to that of the rectangularly sectioned arch wire in that the energy stored in the wire by spring means is transferred to the tooth over time. It is very useful to have the versatility of a combination bracket that allows the use of either technique singly or both techniques simultaneously.

In prior art orthodontic brackets 200, such as the ones described in U.S. Pat. Nos. 5,037,297, 4,941,825, and 4,838,787, it is known to include a curved surface 202 for the wire guide 25 that contacts a wire 40 at a single point under that wire 40. (See generally FIG. 1.) As shown, the wire 40 extends through the wire guide 25 at a position toward the top of the bracket 200 to provide orthodontic correction according to the Begg light wire technique, to which reference is made in U.S. Pat. No. 5,037,297 at col. 1, lines 31-32.

Since the surface 202 contacts the wire 40 at only one point 204, the curved surface 202 permits tooth 206 to tip as it moves into a predetermined orthodontic position in the patient's mouth. (See, e.g., FIGS. 2 and 3.) The starting angular orientation 208 of the tooth 206, in relation to the horizontal, is show in FIG. 2, attached. As tooth 206 moves in the patient's mouth, however, the tooth 206 changes its angular position to an alternative angular position 212, as shown in FIG. 3.

Examples of patented devices which are related to the present invention include U.S. Pat. No. 4,192,070 to Lemchen; U.S. Pat. No. 4,585,413 to Wool; U.S. Pat. No. 3,729,826 to Kesling; U.S. Pat. No. 6,206,690 to Vargas; U.S. Pat. No. 5,971,754 to Sondhi; U.S. Pat. No. 5,823,771 to Nord; U.S. Pat. No. 5,464,349 to Andreiko; U.S. Pat. No. 5,169,311 to Lee; U.S. Pat. No. 5,098,288 to Kesling; U.S. Pat. No. 4,948,367 to Haas; and U.S. Pat. No. 4,927,362 to Snead.

### SUMMARY OF THE INVENTION

One of the disadvantages of incorporating the curved surface 202 on the bracket 200, however, is that, in some instances, the curved surface 202 may permit the tooth 206 to over-tip. In other words, where a curved surface 202 is incorporated into the bracket 200, it is possible to overcorrect the angular orientation of the tooth 206. If it tips too far, the tooth 206 will require subsequent orthodontic attention to readjust the tooth's angular orientation. The tooth 206 may tip too far if the patient fails to show-up for his or her regularly-scheduled orthodontic appointments, for example.

It is, therefore, a failing in the prior art that permits orthodontic overcorrection of the angular orientation of a tooth.

The current invention relates to brackets for attachment to the exterior face of the teeth, having a concave dimple that minimized the contact surface in the slot for accommodation of a wire bow with small contact surface similar to Straight wire technique and an elevated table in providing easy engagement of wire at the initial leveling stage,
whereby the wire bow connects the teeth by way of the brackets, and exerts forces and torques in order to bring the teeth into a final position intended by the orthodontist, which comes as close as possible to the ideal position.

The trapezoid slot form (301) is providing additional root torque to correct rotated tooth root, in an action as an adjunct in de-rotation movement.

Another advantage of current invention is variable attachments can be added to the bracket by using this inventive self-male and female locking mechanism, it broadens the function of the bracket. Examples shown in FIG. 5 and FIG. 6. The attachment will self-locked in place when wire 40 engages with wire 40 in bracket slot.

Different attachment design will provide variation in frictional difference. Low friction attachment may facilitates tipping movement in some needed situation. With this simple interlocking mechanism, while we add or change the interchangeable attachments, we can change Orthodontic torque mechanism as needed base.

Example is the preferable bracket 300 (FIG. 4,5, 6,8, 9, 10, 1113,14,15,16, 18) to add a attachment with a hook connects to base extension (4) slot then passes through the channel (2) and lock the male key 403 into female keyway concavity (7). In particular, the hook can bring about retention of the wire bow in the slot, in combination with a ligature attached to it. It is advantageous if the hook is also configured to be rounded off. When channel (2) is not occupied, the channel can serves as an attachment point for ligatures or additional elements for providing forces and torques.

There is some variety with this invention, such as bracket 400 (FIG. 7, 12,17). the brackets 400 according to the invention can have a fixed ball hook (401)

In many people, the position of the teeth deviates from the ideal position. Optimization of the position of the teeth is desirable for the persons affected, not only for esthetic reasons, but also for medical reasons. For example, an incorrect position of the teeth can lead to a large number of problems in the sector of the stomatognathic system. Particularly in the case of severe deviations of the teeth from the ideal position, orthodontic treatment is almost unavoidable, in order to prevent sequential damage.

For the case that an intrusive tooth movement, i.e. driving the tooth deeper into the jaw, is required as part of the orthodontic treatment, the bracket can be provided with a bite-down plateau. This bite-down plateau represents a flattened region of the bracket on the crown side, which is exposed for contact with the corresponding teeth of the opposite jaw, or with aids affixed to these teeth. In this way, a force is exerted on the bracket and thereby also on the tooth connected with it, by the teeth of the opposite jaw, within the framework of normal chewing and mouth-closing movements, which tooth is intrusively moved farther into the jaw over time. In the case of lingual attachment of the brackets, such bite-down plateaus are particularly used for maxillary front teeth.

The invention will be illustrated using the attached drawings.

### BRIEF DESCRIPTION OF THE DRAWINGS

FIG. 1 is a perspective illustration of a prior art orthodontic bracket;

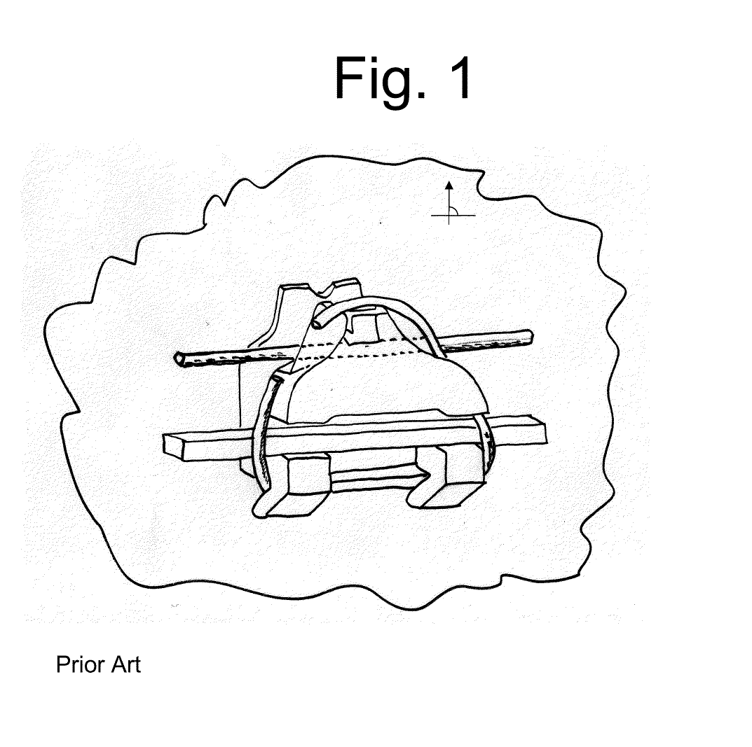

FIG. 2 is a partial cross-sectional view of the prior art shown in FIG. 1, illustrating a starting orientation of the bracket in relation to the wire (40);

FIG. 3 is a partial cross-sectional view of the prior art shown in FIG. 1, illustrating the contact position of the wire to the bracket after the underlying tooth has changed its angular orientation;

FIG. 4 is a partial cross-sectional view of the orthodontic bracket shows a bracket according to the invention, which is attached to a tooth, in a side view, illustrating a starting orientation of the bracket in relation to the wire and the female keyway (7) and channel (2) without male key (403) in position of described interlocking mechanism;

FIG. 5 is a partial sectional view of the orthodontic bracket to describe one of the male key attachment (401,402 and 403) engaged into the female keyway;

FIG. 6 is a partial sectional view of the orthodontic bracket to show different way of interchangeable key male attachment (403) engaged into the female keyway (7);

FIG. 7 is a partial sectional view of the orthodontic bracket to show variation of current invention with fixed bottom attachment.

FIG. 8 is a front view of the orthodontic bracket of the present invention;

FIG. 9 is a perspective illustration of the orthodontic bracket of the present invention;

FIG. 10 is a perspective illustration of the orthodontic bracket of the present invention with interchangeable attachment (401,402 and 403) in place;

FIG. 11 is a perspective illustration of the orthodontic bracket of the present invention with another interchangeable attachment (401,405 and 403) in place;

FIG. 12 is a perspective illustration of the Orthodontic bracket of the present invention with a fixed attachment (301) without male interlocking key showing.

FIG. 13 is the top view of the Orthodontic bracket of the present invention;

FIG. 14 is the bottom view of the Orthodontic bracket of the present invention without attachment;

FIG. 15 is the bottom view of the Orthodontic bracket of the present invention with an interchangeable attachment as in FIG. 10 in place;

FIG. 16 is the bottom view of the Orthodontic bracket of the present invention with another interchangeable attachment as in FIG, 11 in place;

FIG. 17 is the bottom view of the Orthodontic bracket of the present invention with an fixed attachment variation as shown in FIG. 12;

FIG. 18 is the prospective view of the Orthodontic bracket of the present invention engaged with an Orthodontic square wire in slot.

### DESCRIPTION OF THE PREFERRED EMBODIMENTS

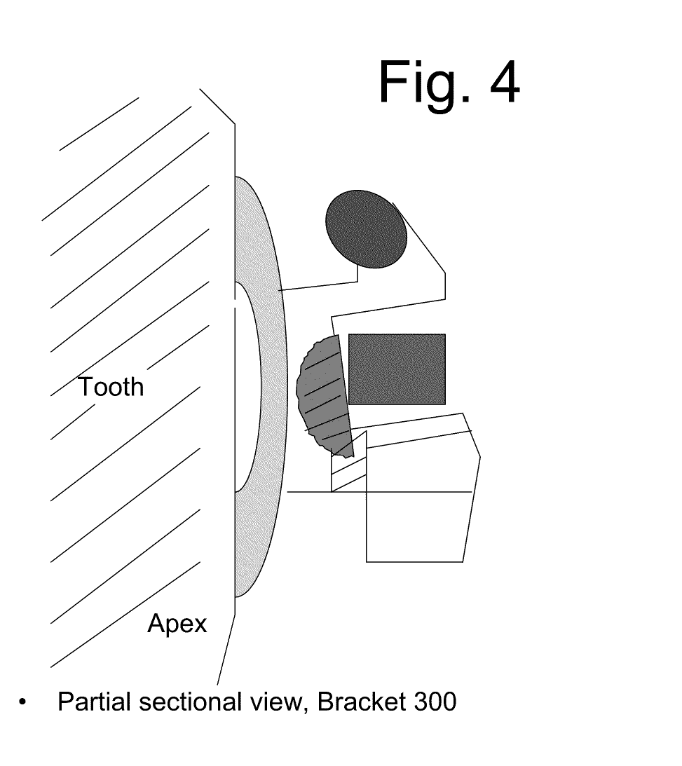

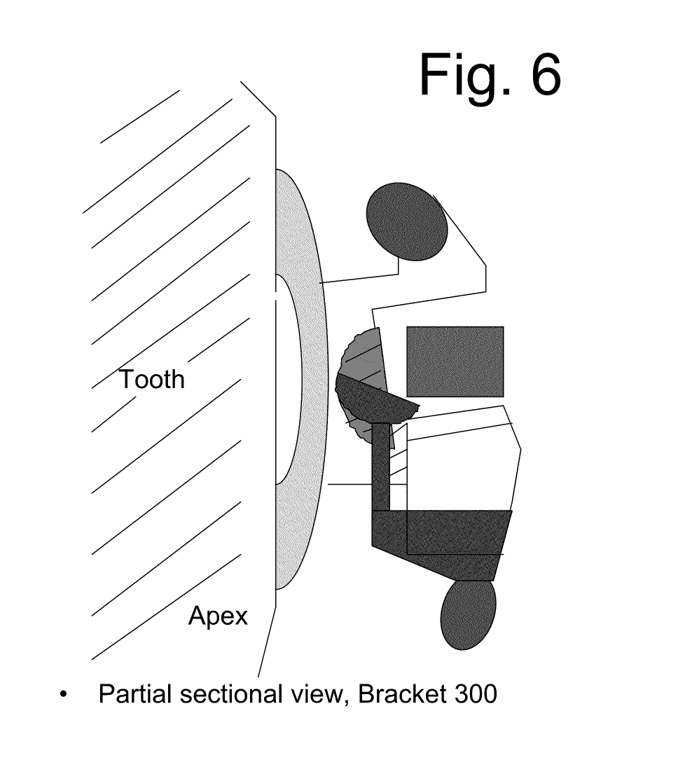

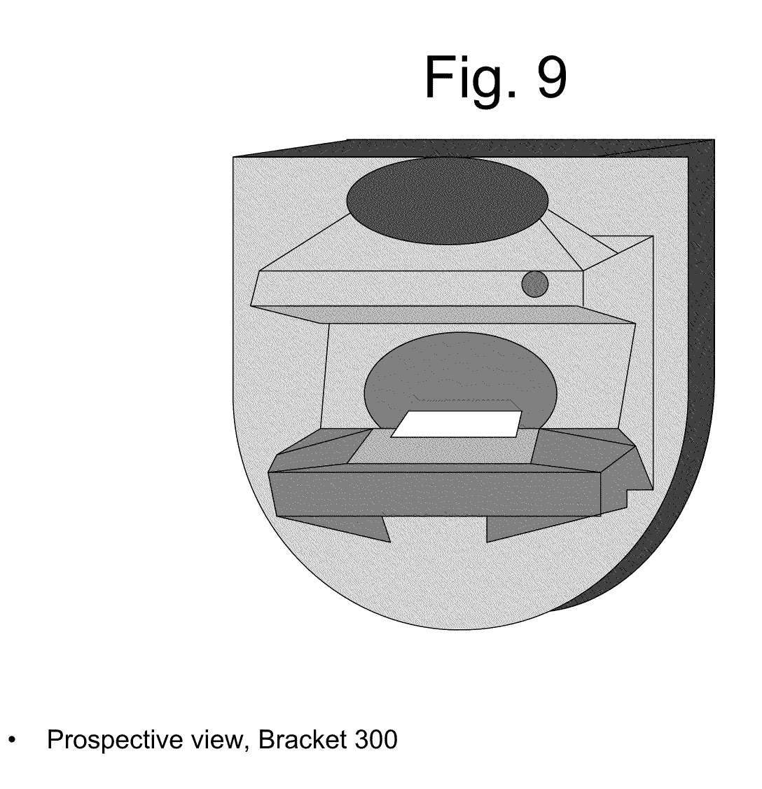

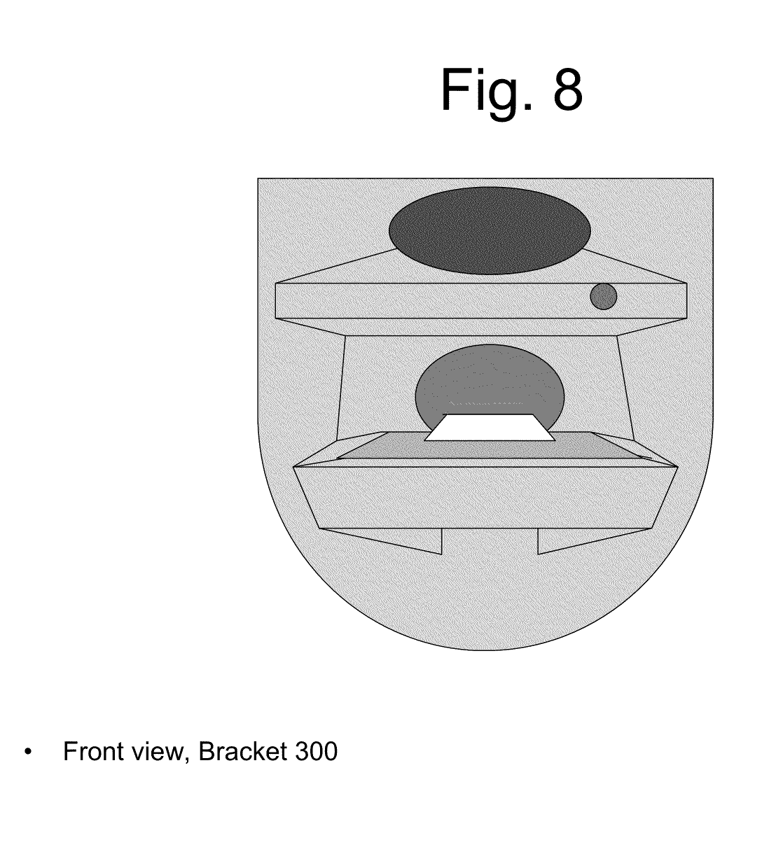

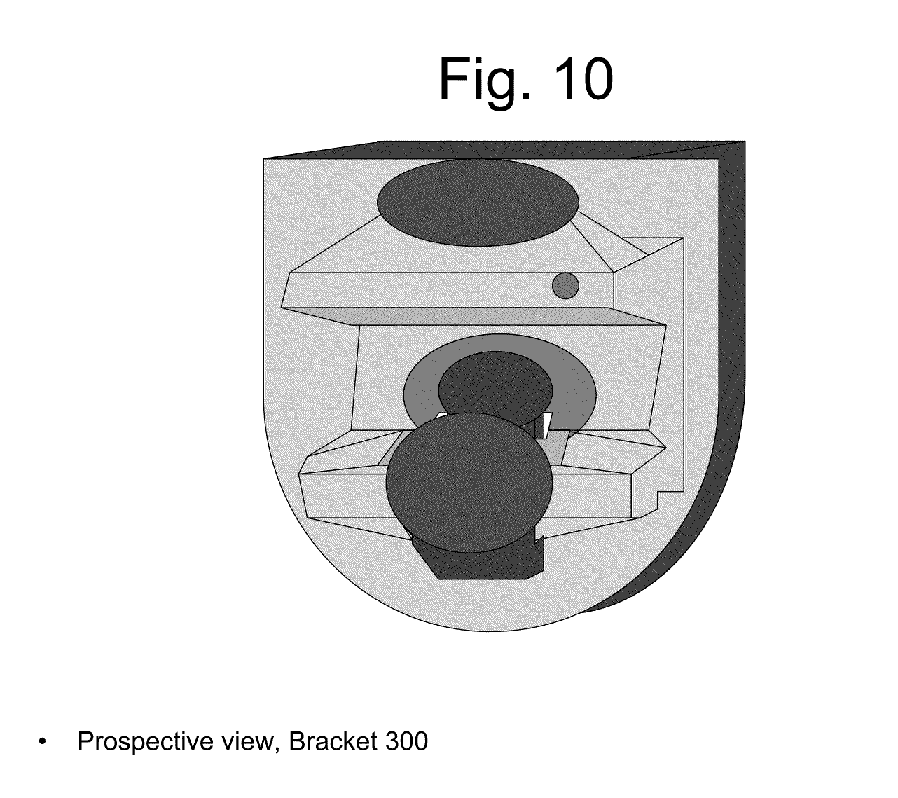

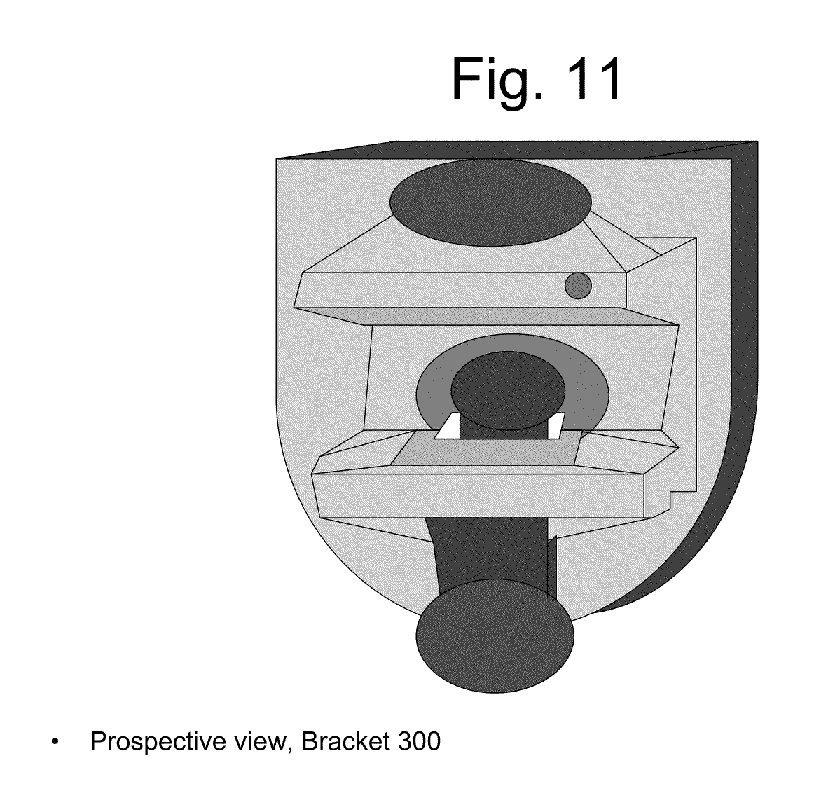

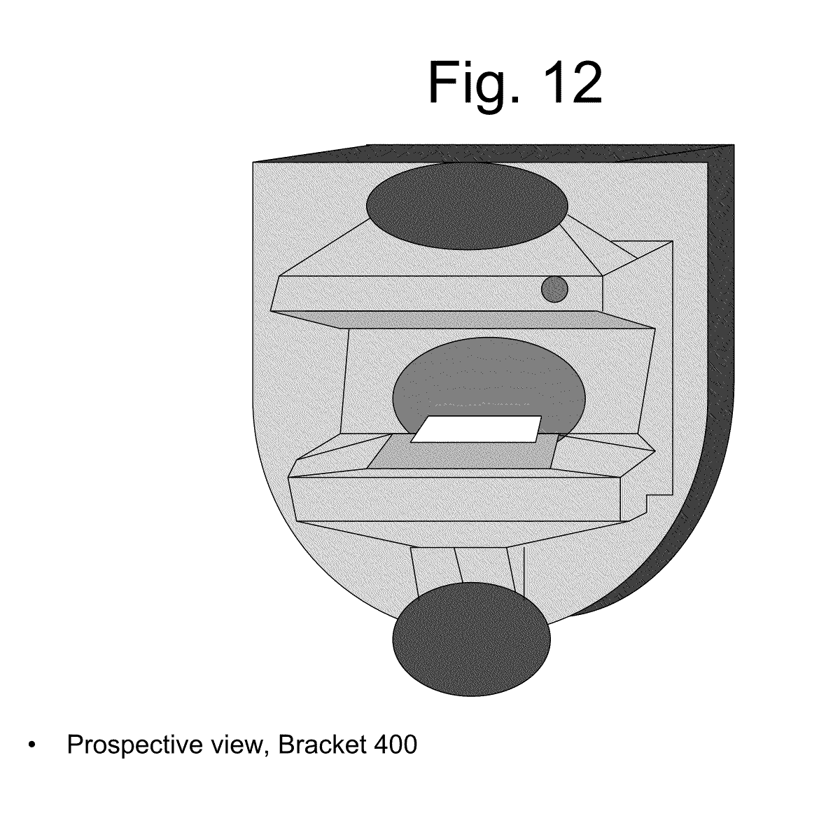

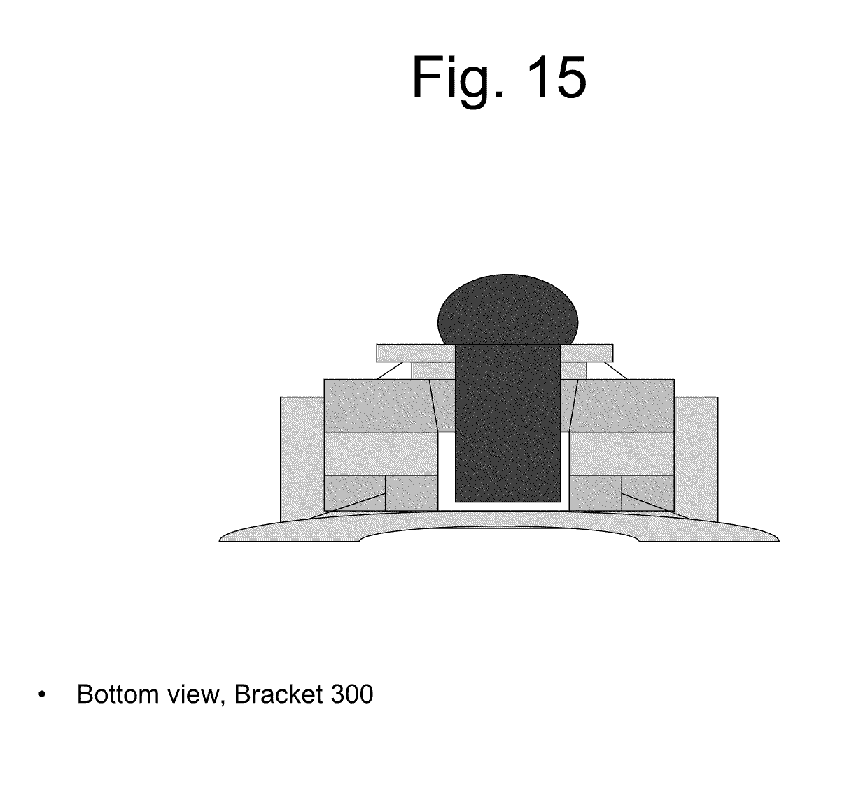

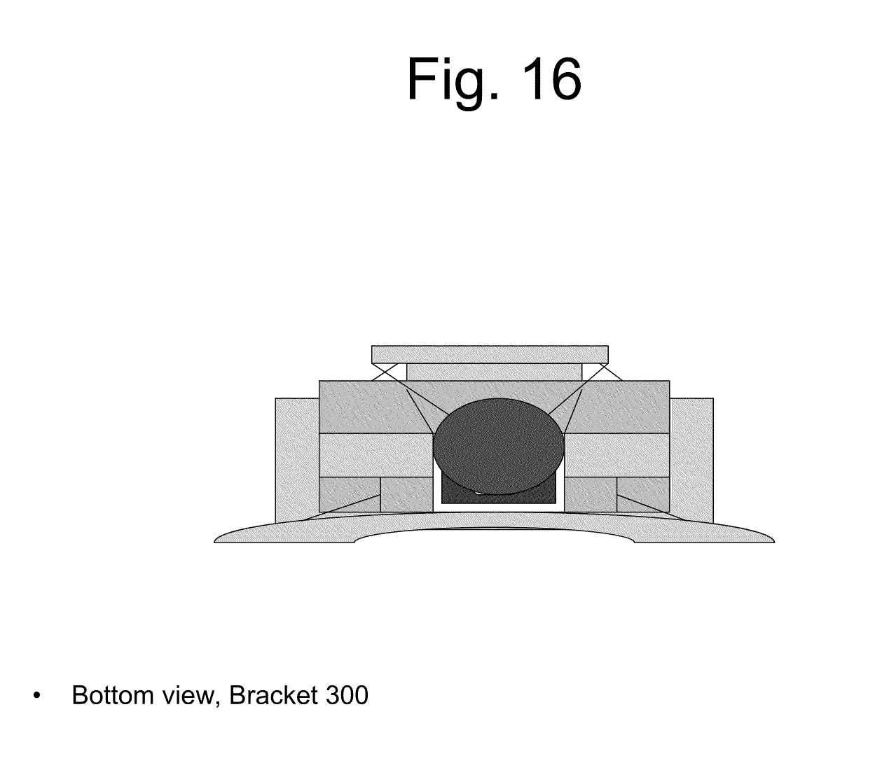

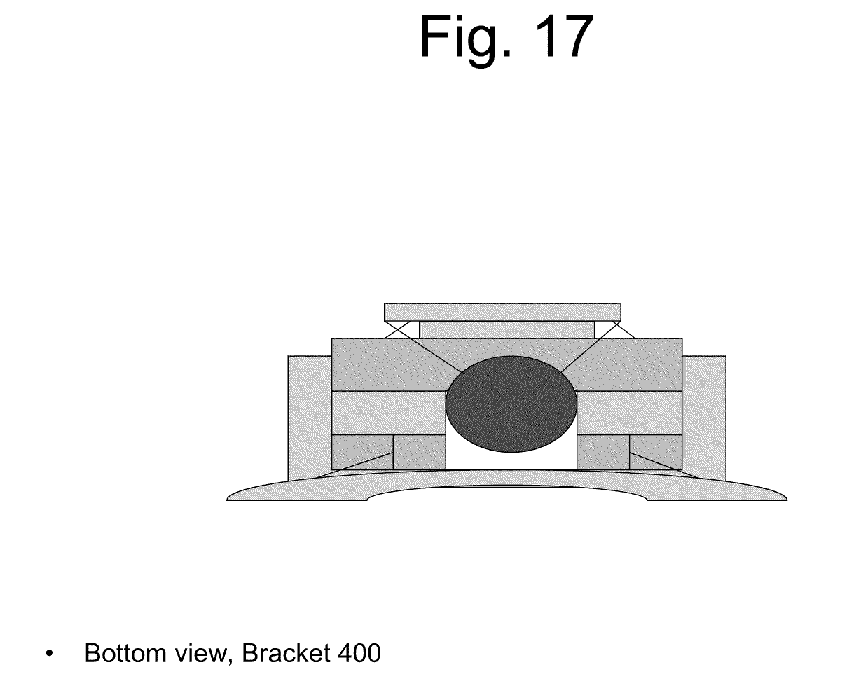

To accomplish the objectives set forth above, the bracket 300 (FIGS. 4, 5, 6, 8, 9, 10, 11, 13, 14, 15, 16 and 18) of the present invention and a variation of bracket 300, which is labeled as bracket 400 (FIGS. 7, 12 and 17) includes a wire slot (301, 302) with angled and elevated table surface 303 to accommodate arch wire size from 0.012″ (inch) to 0.022″ (inch).

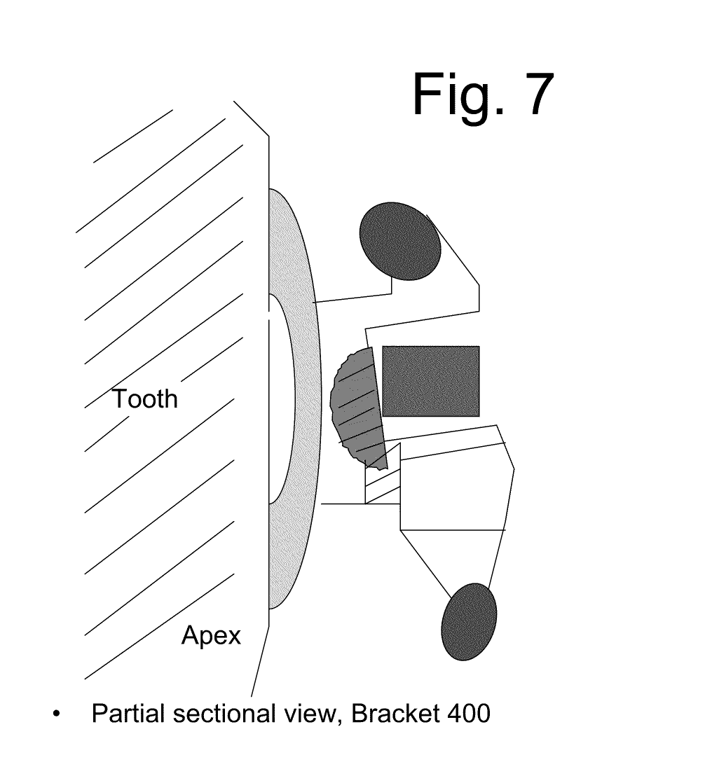

As illustrated in FIGS. 8, the trapezoidal wire slot (301) was formed by an elevated surface 303 and by the other generally planar surfaces 302, 303 that meet one another at an trapezoidal base of 301.

As illustrated in FIGS. 4, 7, 8, 9 and 12. When bracket has no interchangeable male key (403) installed, he female concavity has form a discontinuity and separation of the contact surface of the base planar 301 and make its mechanism similar to the edgewise bracket mechanism when engaged with wire 40.

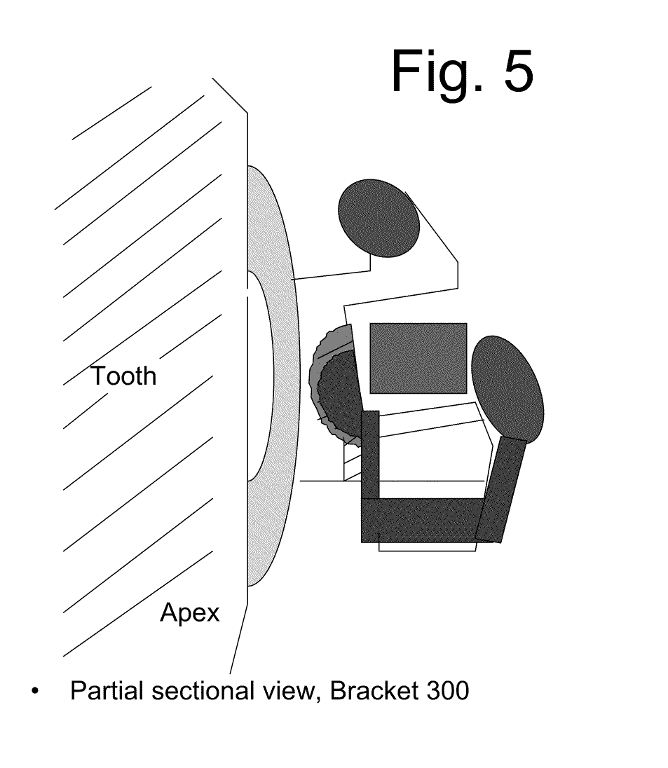

As in FIGS. 5, 6, 10, 11 and 18, when attachment engaged through channel (2) and self-locked in place by Wire 40 or by flexibility of the attachment material as positioned in the bracket 300. The attachment somehow becomes an protrusive object and bracket is in the Begg light wire technique so that wire 40 is held against the interchangeable attachment (403) instead of base of the slot (301).

Wire 40 may be held in place by any technique known to those skilled in the art. For example, wire 40 may be held against base (301) by a suitable elastomeric ringlet if no interchangeable attachment used or by an attachment (401,402 and 403) as shown in FIG. 5;

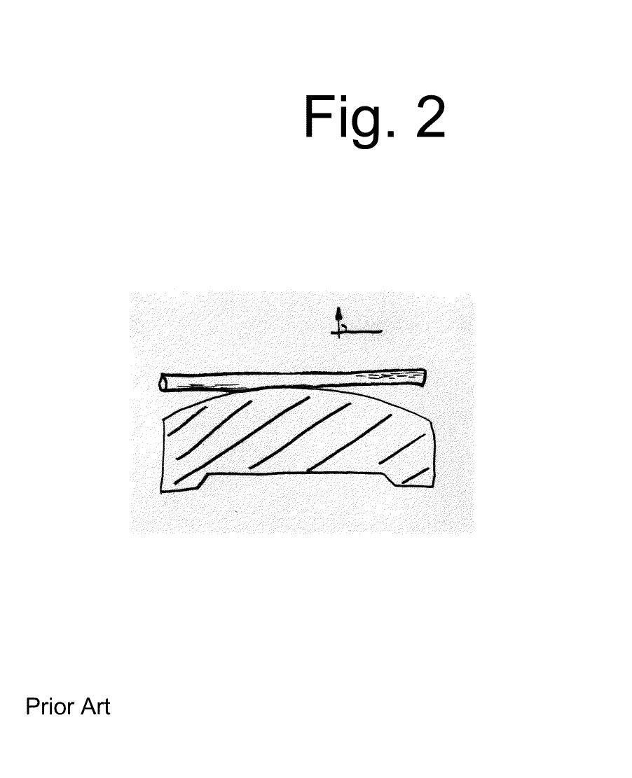

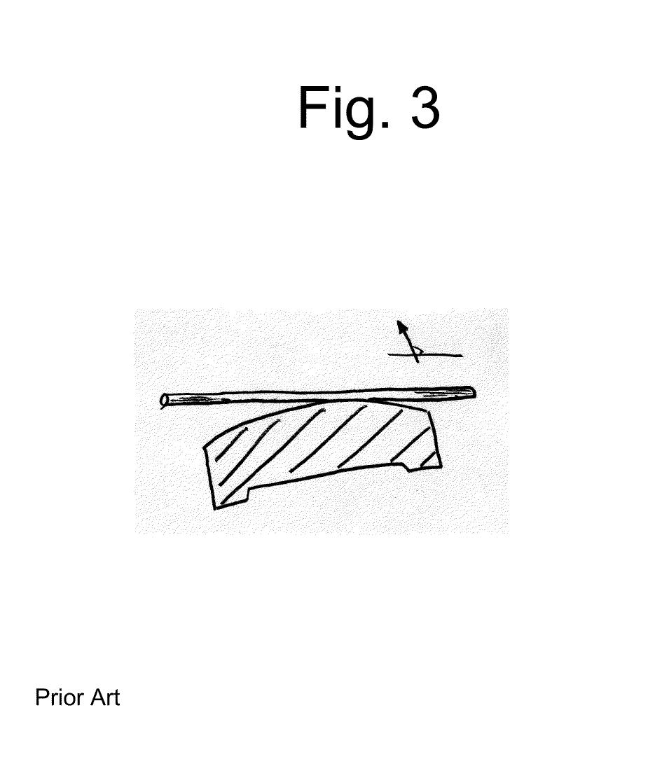

When interchangeable attachment is used and wire 40 is held in place against apex 307, in FIG. 4. It advantageously contacts bracket 300 at a single location (like wire 40 contacts curved surface 202 on bracket 200). As a result, wire 40 may “rock” in either direction as tooth 206 changes its angular position over time. (See, e.g., FIGS. 2-3.) However, planar surfaces 301, house of slot (302) and wire guard (5) provide stop positions to prevent tooth 206 from tipping past a predetermined angular position. In other words, tooth 206 may not tip to an angular position that exceeds the limit provided by planar surface 301, roof of slot (302) and wire guard (5).

If tooth 206 tips to point where wire 40 rests on planar surface 304 (as showed in FIGS. 4 and 8), it cannot tip or rotate further. The planar surface 304, therefore, acts as a stop (or limit) to prevent the tooth 206 from tipping too far from a predetermined position during a typical orthodontic corrective procedure.

In FIGS. 4, 5 and 10; they illustrated the wire guard is not only to provide a guidance of elastomeric ringlet engagement, it also provides a greater limit for torque and tipping angle from horizontal force. As would be understood by those skilled in the art, however, this limit is similar to what the angle 308 provided in FIG. 8 so that a greater “tip” angle for tooth 206 may be permitted in one direction over the other. This may be necessary in certain instances where, for example, tooth 206 requires a considerable amount of adjustment during the course of the orthodontic procedure.

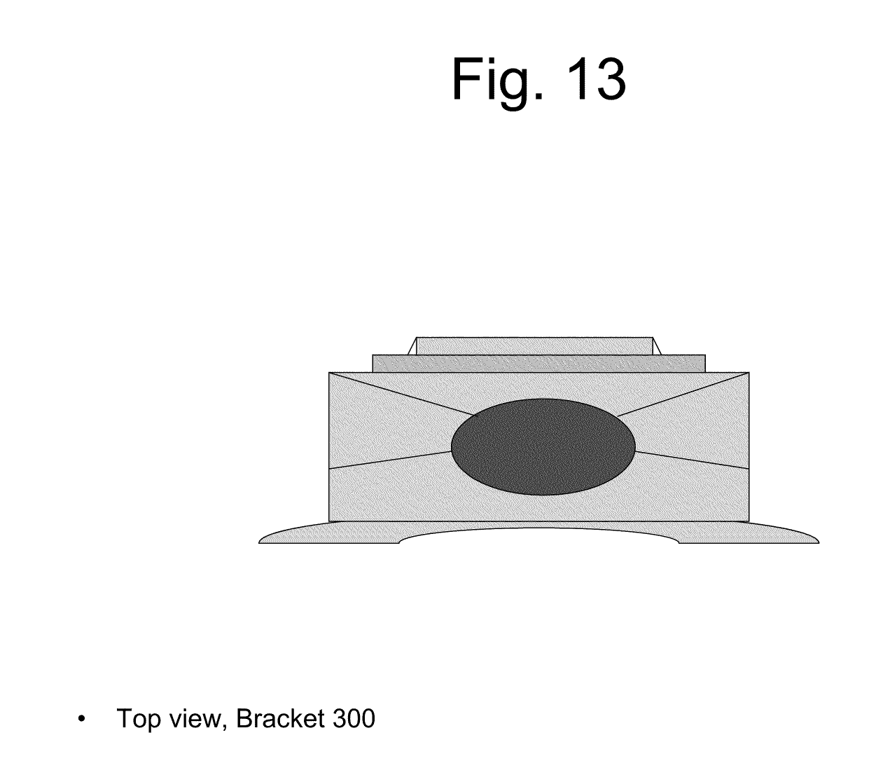

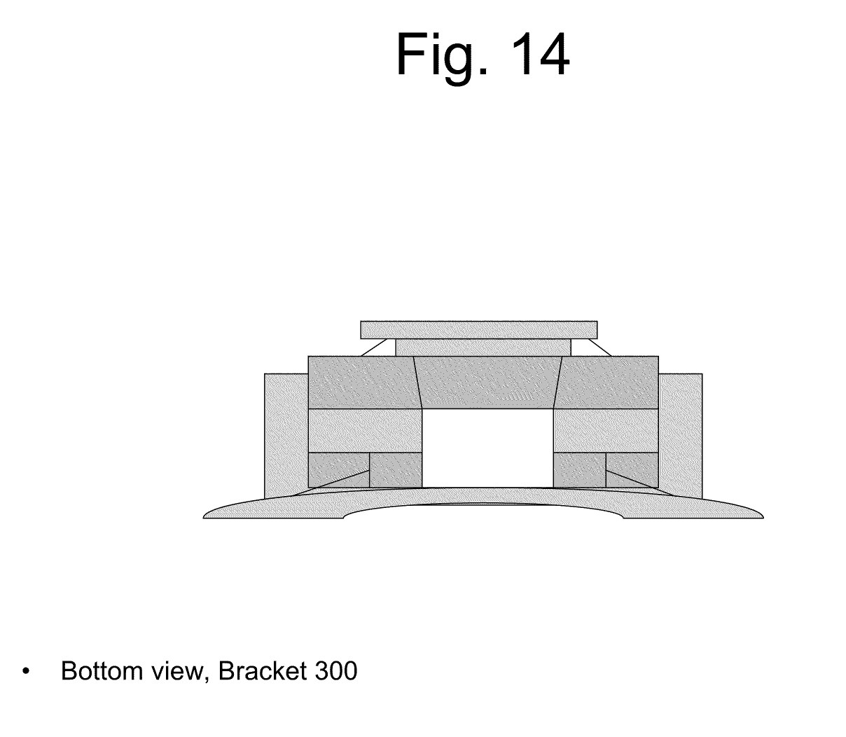

FIGS. 13 and 14 show the bottom and top views of current invention, which showed a rectangular hole (7) opening on the bottom which is used for additional ligature and is a channel (2) for attachments to pass through. Thus, it provides the back bone for the self-locking mechanism for adding interchangeable attachments shown in FIGS. 5, 6, 10, 11, 15, 16 and 18.

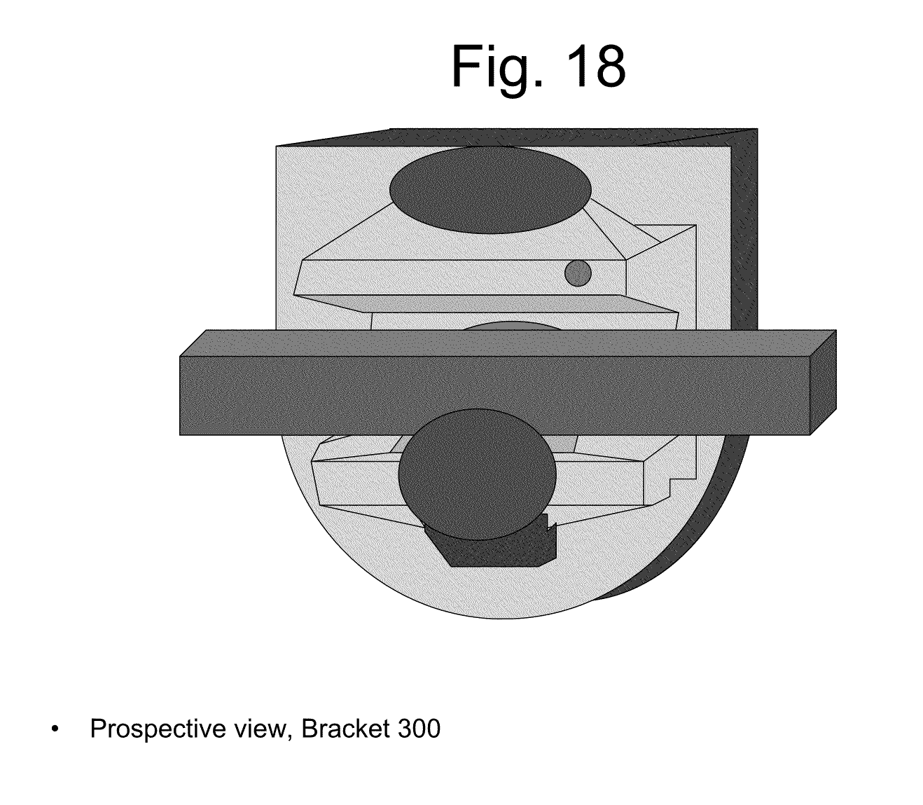

Together with the self-locking mechanism to receive interchangeable attachments, lifted table (303) and wire guard (5) have made this invention unique from prior art. FIG. 18 illustrated the current invention with the relationship with the wire 40 engaged into the Bracket slot.

Although the illustration here describes its shape of current invention; however, examples of variation have shown in FIGS. 7, 12 and 17, which depict a portion of bracket 400, is illustrative of the variation of bracket 300 contemplated within the scope of the present invention, as discussed above. In bracket 400, there is fixed hook at its bottom extension.

In conclusion, according to the description disclosed above, the improved implant root provided by the present invention has the novelty and improvement that a patent should have. And the embodiments given are only for illustrating the present invention; it will be apparent to those skilled in this art that various equivalent modifications or changes without departing from the spirit of this invention, such as increasing or shape changing of the treated surfaces, shall also fall within the scope of the appended claims.

1. The Orthodontic Bracket and Device, of current claim, have a dimple concave Female (7) surface and a channel (2) for attachments to passes through which would allow the female to receive a convex male (403) surface extension from the interchangeable attachments (402 and 405) and form a locking mechanism between concave female surface and the attachment convex male extension when attachment is used during the Orthodontic treatment.

2. Bracket, of current claim, is an Orthodontic device for attachment to an exterior face of the teeth, having an trapezoid-shape slot (301) and for accommodating a wire bow (40), whereby the bracket has a base (307) that rests against the exterior face of the teeth, wherein the slot (301) is let into the base (307) and has a characterized dimple female concavity (7), preferably in the approximate middle center of bracket; thus has smaller portion of contact face on arch wire, and has a characterized receiving channel (2), preferably rectangle or round shape slot or hole, passes through the bracket to embrace additional attachments or to engage with additional wire during the Orthodontic treatment The bracket has a single low profile top inclined plateau (8) and two protruded lower extensions (4) which seats on a horizontal wire guard (5) and characterized with an elevated table (303) to optimize the torque and facilitate the displacement of the dental bow into its ideal position and the fixing of the brackets to the tooth

3. Bracket according to claim 2, wherein the base has all rounded corners and surfaces.

4. Bracket according to claim 2, wherein the base (307) has a roughen surface in contact with surface of tooth.

5. Bracket according to claim 2 wherein the base (307) is configured in rounded, oval, triangle or rhomboid shape.

6. Bracket according to claim 2, wherein the base (307) covers an area .gtoreq.60% of the interior face or exterior face of the teeth.

7. Bracket according to claim 2, wherein the slot (301, 301 and 303) is let into the side of the base (307) that faces towards either the buccal or lingual of the tooth (206).

8. Bracket according to claim 2, two protruded lower extensions (4) directly fused with lower extension (401), including the base (307) is individually established for each tooth.

9. Bracket according to claim 2, wherein the location, the angle of incline, and the depth of the slot (301,302 and 303) are individually adapted for each tooth (206), to the optimized shape of the dental arc after treatment.

10. Bracket according to claim 1 and claim 2, wherein the bracket is produced from a mill-able or cast-able material.

11. Bracket according to claim 10, wherein the bracket consists entirely or partially of Ceramic or Nano-ceramic enforced composite, preferably zirconium oxide and polycrystalline ceramic-alumina oxide

12. Bracket according to claim 10, wherein the bracket consists entirely or partially of metal, preferably titanium.

13. Bracket according to claim 10, wherein the bracket consists entirely or partially of plastic.

14. Bracket according to claim 2, wherein the bracket has a bite-down plateau (8) that serves for contact with corresponding teeth of the opposite jaw.

15. Orthodontic Bracket and Device according to claim 1, wherein the Bracket and device uses this interchangeable interlocking platform (2,7 with 403,402,405) for retention.
